(19) United States
(12) Patent Application Publication
(10) Pub. No.: US 2015/0133014 A1
(43) Pub. Date: May 14, 2015

(54) THERMO-FUSIBLE SHEET MATERIAL

(71) Applicant: CARL FREUDENBERG KG, Weinheim (DE)

(72) Inventors: Steffen Traser, Darmstadt (DE); Steffen Kremser, Heddesheim (DE); Bjoern Hellbach, Birkenau (DE); Matthias Adler, Heppenheim (DE)

(21) Appl. No.: 14/399,517

(22) PCT Filed: May 3, 2013
(86) PCT No.: PCT/EP2013/001309

§ 371 Date: Nov. 7, 2014

(30) Foreign Application Priority Data
May 8, 2012 (DE) 10 2012 009 055.2

(51) Int. Cl. C09J 7/04; C09J 175/06; C09J 5/00

(52) U.S. Cl. CPC C09J 7/043; C09J 5/00; C09J 175/06; C09J 2475/00
USPC 442/64; 427/207.1

(57) ABSTRACT

A thermo-fusible sheet material is provided, particularly for use as a fusible interlining in the textile industry, and having a substrate layer that has a textile material that has an adhesive compound structure thereupon with a polyurethane hot-melt adhesive composition. The thermo-fusible sheet material has a high degree of adhesive strength, particularly on outer fabrics that are difficult to fuse such as, for example, outer fabrics coated with fluorocarbon, silicone or polyurethanes.

### CROSS-REFERENCE TO RELATED APPLICATIONS

This application is a U.S. National Stage Application under 35 U.S.C. §371 of International Application No. PCT/EP2013/001309 filed on May 3, 2013, and claims benefit to German Patent Application No. DE 10 2012 009 055.2 filed on May 8, 2012. The International Application was published in German on Nov. 14, 2013, as WO 2013/167250 A1 under PCT Article 21(2).

### FIELD

This invention relates to thermo-fusible sheet materials, particularly for use as fusible interlinings in the textile industry, which are notable for improved performance properties and improved processability, and also to their production and use as interlinings for textiles.

### BACKGROUND

Interlinings are the invisible scaffolding of clothing. They ensure correct fit and optimal wearing comfort. Depending on application, they augment processability, enhance functionality and stabilize clothing. In addition to clothing, these functions can find application in industrial textile applications, for example furniture, upholstery and home textiles.

Property profiles important for interlinings are softness, springiness, fabric hand, wash and care durability and also adequate abrasion resistance on the part of the backing material in use.

Interlinings can consist of nonwovens, wovens, formed-loop knits or comparable textile sheet materials, which are usually additionally provided with a bonding compound whereby the interlining can be adhered to a top fabric usually thermally via heat and/or pressure (fusible interlining). The interlining is thus laminated onto a top fabric. The various textile sheet materials mentioned have different property profiles, depending on their method of making. Woven fabrics consist of threads/yarns in the warp and weft directions, formed-loop knits consist of threads/yarns connected via a loop construction into a textile sheet material. Nonwovens consist of individual fibers laid down to form a fibrous web which are bonded mechanically, chemically or thermally.

In the case of mechanically bonded nonwovens, the fibrous web is consolidated by mechanical interlacing of the fibers. This utilizes either a needling technique or an interlacing by means of jets of water or vapor. Needling does give soft products, albeit with relatively labile hand, so that this technology has become established for interlinings only in quite specific niches. In addition, mechanical needling requires typically a basis weight >50 g/m², which is too heavy for a multiplicity of interlining applications.

Nonwovens consolidated using jets of water can be produced in lower basis weights, but generally are flat and lack springiness.

In the case of chemically bonded nonwovens, the fibrous web is treated with a binder (an acrylate binder for example) by impregnating, spraying or by means of other customary methods of application, and subsequently cured. The binder bonds the fibers together to form a nonwoven, but has the consequence that a relatively stiff product is obtained, since the binder is widely distributed throughout the fibrous web and adheres the fibers together throughout as in a composite material of construction. Variations in fabric hand/softness cannot be fully compensated via fiber blends or binder choice.

Thermally bonded nonwovens are typically calender or hot air consolidated for use as interlinings. The current standard technology for nonwoven interlinings is pointwise calender consolidation. The fibrous web here generally consists of polyester or polyamide fibers specifically developed for this process, and is consolidated by means of a calender at temperatures around the melting point of the fiber, one roll of the calender having a point engraving. Such a point engraving consists for example of 64 points/cm² and can have a sealing surface of 12% for example. Without a point arrangement, the interlining would be consolidated flattish and be unsuitably harsh in fabric hand.

The above-described different processes for producing textile sheet materials are known and described in textbooks and in the patent literature.

The bonding compounds typically applied to interlinings are usually thermally activatable and consist generally of thermoplastic polymers. The technology for applying these bonding compound coatings is effected according to the prior art in a separate operation onto the fibrous sheet material. By way of bonding compound technology it is typically powder point, paste printing, double point, sprinkling and hotmelt processes which are known and described in the patent literature. Double point coating is currently considered to be the most effective with regard to adherence to the top fabric even after caring treatment and with respect to back-riveting.

Such a double point has a two-layered construction in that it consists of an underpoint and an overpoint. The underpoint penetrates into the base material and serves as blocking layer against bonding compound strike-back and to anchor the overpoint particles. Customary underpoints consist for example of binder and/or of a thermoplastic polymer that contributes to the adhesive force during fusion. Depending on the chemistry used, the underpoint contributes as a blocking layer to the prevention of bonding compound strike back as well as to the anchoring in the base material. It is primarily the overpoint composed of a thermoplastic material which is the main adhesive component in the two-layered composite and which is sprinkled as a powder onto the underpoint. After sprinkling, the excess portion of the powder (between the points of the lower layer) is advantageously sucked off again. After subsequent sintering, the overpoint is (thermally) bonded on the underpoint and can serve as adhesive material in respect of the overpoint.

Depending on the intended purpose of the interlining, different numbers of points are printed and/or the amount of bonding compound or the geometry of the point pattern is varied. A typical number of points is, for example, CP 110 for an add-on of 9 g/m², or CP 52 having an add-on rate of 11 g/m².

Paste printing is also widely used. In this technology, an aqueous dispersion is prepared from thermoplastic polymers, typically in particulate form having a particle size <80 μm, thickeners and flow control agents and is then applied in paste form to the backing ply usually in the form of points by means of a rotary screen printing process. Advantageously, the printed backing ply is subsequently subjected to a drying operation.

It is known that a very wide variety of hot-melt adhesives can be used as bonding media for the hot adherence of interlinings. Hot-melt adhesives, or just hotmelts for short, are well known. Hotmelts are essentially solvent-free products which are applied in the molten state to an adherend, are quick to solidify on cooling and hence are quick to develop strength. It is generally thermoplastic polymers, such as polyamides (PA), copolyamides, polyesters (PES), copolyesters, ethyl vinyl acetate (EVA) and its copolymers (EVAC), polyethylene (PE), polypropylene (PP), amorphous polyalphaolefins (APAO), polyurethanes (PU), etc which are used as hotmelts.

Hotmelts are basically adhesive because, being thermoplastic polymers, they are reversibly meltable and, once in the form of a liquid melt, are capable by virtue of their reduced viscosity (reduced by the process of melting) of wetting the adherend and thereby develop some adhesion to the adherend. In consequence of the subsequent cooling, the hotmelt resolidifies to form a solid body which possesses a high level of cohesion and thereby establishes a bond to the adherend. After bonding has taken place, the viscoelastic polymers ensure that the adhesive bond survives even the cooling process with its volume changes and the associated buildup of mechanical stresses. It is the development of cohesion which confers the bonding forces between the substrates.

The disadvantage with the use of conventional hotmelts is that, owing to the often high melting temperatures, the bonding of thermally sensitive substrates is problematical and that the bonds formed rapidly lose strength in the event of a temperature increase owing to the thermoplastic character of the polymers. The latter effect can be counteracted by chemically crosslinking the polymer molecules to each other after the setting process. The loss of cohesion at increased temperature is reduced/avoided as a result and so the bonding force of the hotmelt is retained. Systems of this type, which are subjected to chemical crosslinking reactions during or after cooling, are known as reactive hotmelts. Reactive hotmelts are described for example in EP1333045A2, DE3231062A1, WO1993011200A1, DE10347628A, DE4339381A1, DE10027957C1, DE102004052756A1 and US20090242123A1.

Bonding compounds based on polyamide or polyester are typically used in the textile sector. However, they do not deliver adequate adherence particularly on difficult-to-fuse top fabrics, for example smooth polyamide top fabrics, hard-twisted top fabrics, viscose top fabrics and also silicone-, fluorocarbon- or polyurethane-coated top fabrics.

### SUMMARY

An aspect of the invention provides a thermo-fusible sheet material comprising: a backing ply comprising a textile material supporting a bonding compound structure, wherein the bonding compound structure comprises a polyurethane hotmelt composition comprising a thermoplastic polyurethane, which is a reaction product of reactants comprising (A) a bifunctional polyisocyanate having an isocyanate content of 5 to 65 proportional parts by weight, and (B) a polyol comprising a polyester polyol, polyether polyol, polycaprolactone polyol, polycarbonate polyol, copolymer of polycaprolactone polyol polytetrahydrofuran, or a mixture of two or more of any of these.

### DETAILED DESCRIPTION

An aspect of the invention provides textile sheet materials which are endowed with bonding adhesives and which display adequate adherence even to difficult-to-fuse top fabrics, as for example to fluorocarbon- or polyurethane-coated top fabrics. The textile sheet materials can be easy to process using customary setting presses, have very good haptic and optical properties, be simple and inexpensive to manufacture, have very good laundering resistance of up to 95° C. and survive even drying conditions with high cycle numbers.

A further aspect of the invention endows textile sheet materials with a high level of elasticity, in particular in the transverse direction.

An aspect of the invention provides a thermo-fusible sheet material particularly for use as a fusible interlining in the textile industry, having a backing ply composed of a textile material supporting a bonding compound structure that comprises a polyurethane hotmelt composition containing a thermoplastic polyurethane in the form of a reaction product of
at least one bifunctional, preferably aliphatic, cycloaliphatic or aromatic, polyisocyanate (A) having an isocyanate content of 5 to 65 proportional parts by weight, with
at least one polyol (B) selected from the group consisting of polyester polyol, polyether polyol, polycaprolactone polyol, polycarbonate polyol, copolymer of polycaprolactone polyol and polytetrahydrofuran and mixtures hereof, and also optionally with
at least one chain extender (C).

According to an aspect of the invention, the sheet material evinces a bonding compound structure comprising a polyurethane-containing hotmelt composition. The latter endows the sheet material of the present invention with a high level of ability to bond particularly to difficult-to-fuse top fabrics, for example hard-twisted, fluorocarbon- or polyurethane-coated top fabrics and/or top fabrics having smooth surfaces. Yet the polyurethane adhesives develop similar bonding forces to conventional top fabrics to the polyamides or polyesters used as standard. In addition, using the thermoplastic polyurethane delivers surprisingly good laundering resistance and high elasticity to the sheet material, in particular in the transverse direction. This accordingly makes possible the use of comparatively stiff nonwovens without incurring disadvantages in the haptic overall performance. It is further also possible to confer a high level of elasticity on sheet materials solely with the polyurethane coating without having to resort to fibers (bicomponent fibers, for example) or yarns having a high level of elasticity. This makes possible the production of novel products having specific properties, for example an elastic waistband interlining based on a conventional polyamide/polyester nonwoven fabric.

The use of thermoplastic polyurethanes is further advantageous in that the textile sheet material of the present invention has a surprisingly soft, elastic, lovely (pleasant) hand. The hand of the interlining is a significant and important test in the textile industry. What is advantageous in particular is that the pleasant hand is achievable without silicone finishes for the base.

The use of thermoplastic polyurethanes is further advantageous in that there is an immense freedom for creative synthesis. The large selection of monomers available for polyurethane synthesis make it simple to achieve desired physical properties such as hardness, elasticity, etc.

The hotmelts are advantageously used in pulverulent form. Particle size is decided according to the area to be printed, for example the desired size of a bonding point. In the case of a point pattern, particle diameter may vary between >0μ and 500μ. It is a fundamental fact that the particle size of the thermoplastic polyurethane is not unitary, but describes a distribution, i.e., a particle size spectrum is concerned at all times. Particle size has to be aligned with the desired application rate, point size and point distribution.

It is conceivable to use reactive hotmelts, for example room temperature solid, meltable isocyanate-terminated polyurethane prepolymers. Reactive hotmelts are preferably used in the temperature range from 100 to 140° C. and initially set physically, by cooling, and then chemically, by reaction with atmospheric humidity. The patent documents US20090242123A1, WO02011120895A1, WO2010068736A2 and WO1999028363A1 may be cited as exemplifying the latter systems.

However, the use of non-reactive hotmelts is preferable in the present invention. They may be used, for example, in the form of films or powders, in particular of linear, hydroxyl-terminated polyurethanes with crystallizing polyester segments, preferably at temperatures in the range from 60 to 190° C., and set physically by cooling and recrystallization.

Non-reactive polyurethane hotmelts may be in pulverulent form and applied by sprinkling, this being particularly advantageous for sticking porous substrates in the manufacture of altogether breathable textile composites. Sprinkling is further advantageous because it is a simple method of application for uses on a large scale. Since thermoactivated powders, for example of hydroxyl-terminated polyurethanes, are already tacky at low temperatures, they are suitable for effecting benign lamination of heat-sensitive substrates, such as high-value textiles for example. Owing to good properties of fluency in the activated state, a firm bond becomes established even at low pressure and within a short contact time; yet the risk of strikethrough into the woven fabric remains minimal.

Bifunctional polyisocyanate (A) preferably comprises C₄₋₁₈ aliphatic and/or C₆₋₂₀ cycloaliphatic and also C₆₋₂₀ aromatic diisocyanates having isocyanate contents of 5 to 65 proportional parts by weight. The use of aliphatic polyisocyanates is advantageous because they give nonyellowing products. The use of aromatic polyisocyanates is advantageous because of their good crystallizability and good mechanical properties.

Of particular suitability are accordingly 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexanes, 1,3- and 1,4-bis(isocyanatomethyl)cyclohexanes, 1-isocyanato-3,3,5-trimethyl-5-isocyanatomethylcyclohexane (isophorone diisocyanate, IPDI), 4,4′-diisocyanatodicyclohexylmethane (H₁₂MDI, HMDI), 1-isocyanato-1-methyl-4(3)-isocyanatomethylcyclohexane and bis(isocyanatomethyl)norbornane and/or isomeric mixtures thereof and also 2,4-tolylene diisocyanate (TDI), 1,5-naphthalene diisocyanate (NDI), 3,3′-dimethyl-4,4′-biphenylene diisocyanate (TODI), 2,2′-diphenylmethane diisocyanate (2,2′-MDI), 2,4′-diphenylmethane diisocyanate (2,4′-MDI), 4,4′-diphenyl-methane diisocyanate (4,4′-MDI) and/or isomeric mixtures thereof.

The aliphatic and cycloaliphatic diisocyanates 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (H₁₂MDI, HMDI), 1-isocyanato-1-methyl-4(3)-isocyanatomethylcyclohexane and bis(isocyanatomethyl)norbornane have been found to be particularly suitable.

Particularly preferred polyisocyanates as per A are 1,6-diisocyanatohexane (HDI), 1-isocyanato-3,3,5-trimethyl-5-isocyanatomethylcyclohexane (isophorone diisocyanate, IPDI) and 4,4′-diisocyanatodicyclohexylmethane. 1,6-Diisocyanatohexane (HDI) is a particularly preferred polyisocyanate as per A.

Suitable polyols as per B include, for example, polyester polyols, preferably having a molecular weight of 400 g/mol to 6000 g/mol, polyether polyols having a molecular weight of 400 g/mol to 6000 g/mol, polycaprolactone polyols, preferably having a molecular weight of 450 g/mol to 6000 g/mol, polycarbonate polyols, preferably having a molecular weight of 450 g/mol to 3000 g/mol, and also copolymers of polycaprolactone and polytetrahydrofuran, preferably having a molecular weight of 800 g/mol to 4000 g/mol.

Particularly preferred polyols as per B are polyester polyols having a molecular weight of 1000 g/mol to 4000 g/mol. These polyols are notable for particularly good mechanical properties, in particular with regard to elasticity, abrasion, rebound properties, modulus values, etc, coupled with relatively low costs for the raw material.

A polyester polyol in the context of the present invention is a polyester having more than one OH group, preferably two terminal OH groups. They are obtainable in a known manner, for example from aliphatic hydroxycarboxylic acids or from aliphatic and/or aromatic dicarboxylic acids and one or more diols.

Examples of suitable starting materials are succinic acid, adipic acid, suberic acid, azelaic acid, sebacic acid, dodecanedioic acid, glutaric acid, glutaric anhydride, phthalic acid, isophthalic acid, terephthalic acid, phthalic anhydride, ethylene glycol, diethylene glycol, 1,4-butanediol, 1,6-hexanediol, neopentylglycol and ε-caprolactone.

It is preferable to use a readily crystallizing polyester polyol in the present invention. Suitable crystallizing polyester polyols include for example polyester polyols based on linear, preferably uncrosslinked aliphatic dicarboxylic acids of 6 to 12 carbon atoms in the molecule such as, for example, adipic acid and dodecanedioic acid and linear diols of 4 to 8 carbon atoms in the molecule, preferably having an even number of carbon atoms such as, for example, 1,4-butanediol and 1,6-hexanediol. Polycaprolactone derivatives based on bifunctional starter molecules such as 1,6-hexanediol for example are also particularly suitable.

It is particularly preferable to use a 1,4-butanediol adipate having a molecular weight of 2000 g/mol.

Suitable chain extenders as per C are dihydric aliphatic C₁₋₈ alcohols, e.g., ethylene glycol, 1,2-propanediol, 1,3-propanediol, 1,3-butanediol, 1,4-butanediol, 2,3-butanediol, cyclohexanedimethanol (CHDM) and 1,6-hexanediol.

Preferred chain extenders as per C have an even number of carbon atoms. This concerns 1,3-butanediol, 1,4-butanediol, 2,3-butanediol and isomeric mixtures thereof and also 1,6-hexanediol. 1,4-Butanediol and 1,6-hexanediol are particularly preferred chain extenders as per C.

Components A, B and C are preferably reacted with each other in the following quantitative ratios: A=5-25 parts by weight, B=100 parts by weight, C=0.5-15 parts by weight. The molar ratio between polyisocyanate A and the alcohol-functionalized components, polyol B and chain extender C, is preferably between 0.7 and 1.0, more preferably between 0.9 and 1.0 and yet more preferably between 0.94 and 0.98.

The melting point of a thermoplastic polyurethane can be controlled inter alia via the molar ratio between polyisocyanate A and the alcohol-functionalized components, polyol B and chain extender C, since the polymeric chains become shorter and shorter the further the molar ratio departs from 1.0. For particularly low-melting, thermoplastic polyurethanes it may be advantageous for the molar ratio to be adjusted to values between 0.7 and 0.9, preferably between 0.8 and 0.9 and more preferably between 0.85 and 0.89.

Molar ratio, as a person skilled in the art will know, refers to the ratio between the number of moles of isocyanate groups and the number of moles of alcohol groups. An equimolar ratio means that the number of moles of isocyanate groups and the number of moles of alcohol groups is the same and that the molar ratio is 1.0. The molar ratio is below 1.0 when alcoholic groups are present in excess and above 1.0 when isocyanate groups are present in excess. A molar ratio above 1.0 is not very suitable for the polyurethane bonding compounds of the present invention, since free isocyanate monomer may be present when there is an excess of isocyanate groups.

Practical tests have shown that a non-reactive polyurethane hotmelt composition based on at least one bifunctional polyisocyanate (A) having isocyanate contents of 5 to 50 proportional parts by weight, preferably 5 to 25 proportional parts by weight, and a mixture consisting of B) a polyester polyol, preferably 1,6-hexanediol adipate with an OH number of 56 and a functionality of 2 and C) a mixture of the chain extenders 1,4-butanediol and 2,3-butanediol in a ratio of 80:20 gives particularly good results. The weight proportion of polyester polyol component B) is advantageously 100 parts by weight. Advantageously, the ratio of A:B+C is so chosen that the molar ratio of NCO:OH is from 0.7 to 1.0, preferably from 0.9 to 1.0 and more preferably from 0.94 to 0.98. For applications which, as described above, require a particularly low melting point, it is particularly advantageous to adjust the molar ratio to values between 0.85 and 0.89.

The melting point range of the polyurethane hotmelt composition is preferably 80-190° C., more preferably 90-150° C., yet more preferably 100-130° C.

The MFI value of the polyurethane hotmelt composition is preferably [160° C./2.16 kg]: 1-200 g/10 min, more preferably 5-120 g/10 min, yet more preferably 10-80 g/10 min, as measured to DIN ISO 1133. The polyurethane hotmelt composition is obtainable in a simple manner in a batch operation conducted for example as follows:

The polyol is maintained at 90° C. under a vacuum for a period of two hours for devolatilization and dewatering. The polyol is subsequently heated to 100° C., at which point a catalyst, additives such as, for example, hydrolysis and aging control agents and also the chain extender(s) are admixed in succession under agitation. The polyisocyanate is admixed at the end under agitation. The ensuing exothermic reaction causes a pronounced increase in the temperature of the reaction mixture. At the same time, the viscosity of the reaction mixture rises more and more as the reaction continues, so the reaction mixture will generally be poured out when the reaction temperature, following the initial pronounced increase, has settled on an approximately constant value. This single-stage reaction of the components is known as a one-shot process.

Comparatively large batches benefit from a continuous operation via a reaction extruder.

The sheet material of the present invention further comprises a backing ply. The choice of the textile material to be used for the backing ply is made in view of the particular intended application and/or the particular quality requirements. Wovens, knits or the like are suitable, for example. The invention imposes no in-principle limits here whatsoever. A person skilled in the art is readily able to find the combination of materials which is suitable for his or her purposes. Preferably, the backing ply consists of a nonwoven fabric.

The nonwoven fabric as well as the threads or yarns of the textile materials can consist of manufactured fibers or else of natural fibers. The manufactured fibers used are preferably polyester, polyamide, regenerated cellulose and/or binder fibers and the natural fibers, wool or cotton fibers.

The manufactured fibers may comprise crimpable, crimped and/or uncrimped staple fibers, crimpable, crimped and/or uncrimped directly spun continuous filament fibers and/or finite fibers, such as meltblown fibers. The backing ply may have a single- or multi-ply construction.

The nonwoven fabric can be produced using the technologies described at the beginning. The bonding of the fibers of the fibrous web to form a nonwoven fabric can be effected mechanically (conventional needling, water jet technology), by means of a binder or thermally. However, a moderate nonwoven fabric strength is sufficient for the backing ply prior to printing, since in the course of being printed with the mixture of binder and thermoplastic polymer the backing ply is additionally binder treated and consolidated. The moderate strength needed for the nonwoven fabric can also be achieved using inexpensive fiber raw materials, provided they meet the fabric hand requirements. Process management can also be simplified.

When staple fibers are used, it is advantageous to card them with at least one roller card to form a fibrous web. Random lapping is preferable here, but combinations of longitudinal and/or transverse lapping and/or even more complicated roller card arrangements are also possible when specific nonwoven fabric properties are to be made possible, and/or when multi-ply fibrous structures are desired.

Of particular suitability for interlinings are fibers having a fiber linear density of up to 6.7 dtex. Coarser linear densities are normally not used on account of their considerable fiber stiffness. Preference is given to fiber linear densities in the region of 1.7 dtex, but microfibers having a linear density <1 dtex are also conceivable.

In one preferred embodiment of the invention, the bonding compound structure is constructed as a two-ply bonding compound structure comprising an underlayer, lying directly on the sheet material, and an overlayer, arranged on the underlayer and comprising the thermoplastic polyurethane hotmelt composition.

The underlayer here may contain a binder and/or a thermoplastic polymer. It is preferable for the purposes of the present invention for the binder and/or the thermoplastic polymer to be a polyurethane, although in this case a polyurethane binder is a polymer having a melting point >190° C. which does not contribute to the adhesive force developed during fusion. Such double-layered bonding compound points are notable for the low strike-back of bonding compound, since the binder-containing layer applied first acts as a blocking layer. On admixing the underpoint with a thermoplastic polymer having a melting point <190° C., preferably a polyurethane in the present invention, the latter does make a contribution to the adhesive bond in addition to that due to the overpoint. However, the back-riveting of the interlining deteriorates as a result.

The binder may be a binder of the acrylate, styrene-acrylate, ethylene-vinyl acetate, butadiene-acrylate, SBR, NBR and/or polyurethane type or a mixture of the abovementioned substances. The amount of binder in the underlayer is preferably in the range from 5 wt % to 70 wt %. The binder preferably likewise comprises polyester polyurethanes, preferably aliphatic polyester polyurethanes, in particular the polyester polyurethanes described above, since they have an excellent filming property and interact with each other physically in a good way (filmingly). Chemical crosslinking is an option to further increase the resistance to back-riveting. This is advantageous when flexibility and elasticity are less relevant. The advantage over acrylate dispersions, for example, resides in the higher flexibility and elasticity, a lower permanent elongation, lower crosslinking temperatures and the superior attachment to the polyurethane overlayer.

The aqueous underpoint dispersions may further comprise assistants to contribute inter alia to viscosity adjustment and to the runnability of the paste. A suitable binder composition can vary the haptics of the interlining within wide limits.

In one preferred embodiment of the invention, the overlayer contains the thermoplastic polyurethane in an amount of 0.1 to 20 g/m². The underlayer preferably contains the thermoplastic polyurethane in an amount of 0.1 to 20 g/m². In a particularly preferred embodiment of the invention, both the overlayer and the underlayer contain the thermoplastic polyurethane in an amount of preferably 2 to 15 g/m². This embodiment delivers a particularly high elasticity for the interlining.

It is also conceivable for the overlayer and/or the underlayer to contain, in addition to the thermoplastic polyurethane, still further thermoplastic polymers. The thermoplastic polymers other than the thermoplastic polyurethane may be, for example, (co)polyester-, (co)polyamide-, polyolefin-, ethylene-vinyl acetate-based polymers and/or combinations (mixtures and chain growth addition copolymers) of the recited polymers and be present in a coating weight of 0.1 to 20 g/m².

The inventors found that suitable selection of the composition for the underpoint will provide a sheet material possessing a particularly high level of transverse elasticity. Practical tests have shown that the composition of the underpoint has a distinctly greater effect on the transverse elasticity of the sheet material than the composition of the overpoint has.

In one preferred embodiment, as noted above, the underlayer utilizes a polyurethane as a binder having a melting point >190° C. and/or a thermoplastic polymer having a melting point <190° C. This polyurethane is preferably notable for a low Shore hardness and a very flexible, elastic structure.

The polyurethane binder and/or the thermoplastic polyurethane in the underlayer may be not only in pure form but also in the form of blends. In order to endow the sheet material with a high level of transverse elasticity, it will prove advantageous for the polyurethane underpoint to contain the polyurethane binder and/or the thermoplastic polyurethane in an amount of 10 to 100%, preferably 30 to 100%, more preferably 60 to 100%, all based on total underlayer mass. Suitable polymers for blending include, in particular, polyacrylates, ethylene-vinyl acetates, butadiene-acrylates, silicones, styrene-butadiene rubbers or nitrile-butadiene rubbers. Self-crosslinking polyacrylates in particular are preferred polymers for blending with the polyurethane. Self-crosslinking polyacrylates preferably have a low glass transition temperature of, in particular, 0° C. to −20° C.

In one preferred embodiment, the polyurethane binder having a melting point >190° C. comprises an aqueous polyurethane dispersion.

Useful polyurethane dispersions include not only polyester polyurethane dispersions but also polyether polyurethane dispersions. Where applications require a polyurethane binder of low glass transition range and/or good hydrolysis resistance, polyether polyurethane dispersions are preferable. Where applications require a polyurethane binder having good mechanical properties such as, for example, abrasion, polyester polyurethane dispersions are preferable.

Useful polyurethane dispersions include not only aromatic but also aliphatic polyurethane dispersions. Owing to the lightfastness of aliphatic isocyanates, however, aliphatic polyurethane dispersions are preferable.

The solids content of the polyurethane dispersion may be between 10% and 70%, preferably between 15% and 60%, more preferably between 20% and 60% and yet more preferably between 30% and 50%.

The polyurethane dispersion may be stabilized using internal and/or external anionic, cationic or neutral emulsifiers.

The pH of the polyurethane dispersion is preferably in the range from 4.0 to 11.0, more preferably between 5.0 and 10.0, more preferably between 6 and 9.

Ideally, after the water has evaporated and the polyurethane particles have filmed, the polyurethane binders are notable for good mechanical properties. The Shore hardness of the polyurethane binder used in the underlayer is advantageously in the range from 50 to 85 Shore A, preferably in the range from 50 to 70 Shore A and more preferably in the range from 55 to 65 Shore A. It is further advantageous for the polyurethane binder to have a maximum breaking extension in the range from 400 to 1200%, preferably in the range from 600 to 1200% and more preferably in the range from 800 to 1200%. Binder tensile strength is advantageously in the range between 20 and 45 MPa and more preferably between 25 and 45 MPa.

The polyurethane binder ideally possesses a good level of low temperature flexibility. The glass transition range of the polyurethane therefore preferably lies at below 10° C., more preferably at between −40° C. and +10° C. and especially at between −20° C. and 0° C.

Overlayer and underlayer may advantageously be applied using conventional double-point coating technology. The underpoint may be formed using polyurethane binders in the form of polyurethane dispersions. These may have a melting point >190° C. and hence make no contribution to the adhesive effect during fusion. The advantage with such a binder underpoint is that it is simple to construct such that it is, for example, soft, nontacky, elastic, filming, compatible with further additives, lightfast (nonyellowing). The use of polyurethane binders further leads to a substantial improvement in the attachment to the polyurethane overpoint and hence to an increase in the delamination resistance of the bonding compound system. A binder underpoint offers the advantage that it may be crosslinked physically or chemically and back-riveting is appreciably reduced as a result.

The underpoint may further contain thermoplastic polymers which have a melting point <190° C. and thereby contribute to the adhesive effect during fusion. An underpoint containing thermoplastic polymers, preferably thermoplastic polyurethane, in particular aliphatic polyester polyurethane, augments the adhesive effect of the overpoint, but also delivers a higher back-riveting value. The use of polyurethanes in the underpoint provides significantly superior attachment of the overpoint and thus not only enhances the delamination resistance but also reduces powder shedding. The advantages over polyamides, for example, are much improved anchorage to the overpoint, a higher level of elasticity and flexibility. In addition, the adhesive bonding to coated top fabrics is augmented.

As explained, the thermoplastic polyurethane in the overpoint may be blended with the commonly used thermoplastics, for example. PA, PES, PP, PE, ethylene-vinyl acetate, copolymers, etc will prove particularly suitable. The thermoplastic polyurethane may also be co-extruded (compounded) with the further thermoplastics.

The underpoint similarly allows for a very wide variety of combinations. Thus, combinations with commonly used thermoplastics (PA/PES/polyolefins, ethylene-vinyl acetate, copolymers, etc) but also with commonly used binders (acrylate dispersions, silicone dispersions, etc) may be used.

It is advantageous for the interlining sector when the thermoplastic polyurethane is produced in the form of a granular material possessing good grindability. Both in respect of the overpoint fraction (generally 80-200 μm) and in respect of the underpoint or a possible paste application (0-80 μm), there should advantageously be grindability within these limits. The ground particles should ideally have a round geometry in order that unproblematic sprinkling/incorporation and sintering may be ensured.

The TPUs in the present invention may also be used with other commonly used coating methods in the interlining sector, such as powder point, paste print, double-point, sprinkling or hotmelt processes, scattering coating, etc. This is advantageously done using other particle size distributions or, for example, a paste formulation (TPUs in pastes).

It is likewise conceivable for there to be no clear phase boundary apparent between the polyurethane overlayer and the polyurethane/binder underlayer. This may be the result for example of applying the thermoplastic polymer in particulate form in admixture with a binder, for example in the form of a dispersion, and optionally still further components. After application, the binder separates from the coarser particles, which come to rest more on the upper side of the bonding area, for example the point surface. The binder, in addition to becoming anchored in the backing ply and additionally bonding said backing ply, also binds the coarser particles. At the same time, a partial separation of the particles and the binder occurs at the surface of the backing ply. The binder penetrates more deeply into the material, while the particles accumulate at the surface. As a result, the coarser particles of the polymer end up bound into the binder matrix, but at the same time their free (surface) area at the surface of the nonwoven fabric is available for direct adhesive bonding to the top fabric. A structure resembling a double point comes to be developed but in contrast to the way this structure is produced in the known double point process, only a single process step is required and, moreover, the costly and inconvenient removal of superfluous powder by suction is no longer needed. The interlinings thereby acquire higher elasticity and resilience than those comprising conventional, polyamide- or polyester-based polymers.

The double point based on a preferably aqueous dispersion as underpoint and sprinkled powder as overpoint is preferably applied to the backing ply in a point pattern, as described above. This amplifies the softness and springiness of the material. The point pattern may have a regular distribution or a random distribution. However, the printing process is not in any way restricted to point patterns. The double point or the paste may be applied in any desired geometries, including for example in the form of lines, stripes, net- or lattice-type structures, points having rectangular, diamond-shaped or oval geometry or the like.

A preferred process for producing a thermo-fusible sheet material of the present invention comprises the measures of:
a) providing a backing ply,
b) applying a bonding compound structure comprising a polyurethane hotmelt composition containing a thermoplastic polyurethane in the form of a reaction product of
   at least one bifunctional polyisocyanate (A) having an isocyanate content of 5 to 50 proportional parts by weight, preferably 5 to 25 proportional parts by weight, with
   at least one polyol (B) selected from the group consisting of polyester polyol, polyether polyol, polycaprolactone polyol, polycarbonate polyol, copolymer of polycaprolactone polyol polytetrahydrofuran and mixtures hereof, and also optionally with
   at least one chain extender (C), to selected areal regions of the backing ply, and
c) thermally treating the backing ply obtained from step b) to sinter the thermoplastic polymer onto/with the surface of the backing ply.

The bonding compound structure is preferably formed as a two-layered bonding compound structure, as explained above, featuring an underlayer and an overlayer. To form the underlayer, it is advantageously a binder and/or a thermoplastic polymer, preferably in the form of an aqueous dispersion, which are first applied to the sheet material. These may be followed by the application of the thermoplastic polyurethane, preferably in the form of a sprinkled powder.

The backing ply comprising a textile material and/or nonwoven fabric may be printed with the bonding compound structure directly in a printing press. It may be possibly sensible for this purpose to precede the printing operation by the backing ply being wetted with textile auxiliaries such as thickeners (partially crosslinked polyacrylates and salts thereof, for example), dispersants, wetting agents, flow control agents, fabric hand modifiers or treated in some other way so as to enhance printing process consistency.

The invention further provides the method of using a sheet material of the present invention as an interlining for fusion to a top fabric, preferably having an air permeability <100 dm³/s*m² at a test pressure of 200 Pa measured in accordance with EN ISO 9237.

The sheet material will prove particularly suitable for fusion to a top fabric which comprises, at least on that side which faces the interlining, a coating based on silicone, fluorocarbon or a polyurethane.

A very wide variety of top fabrics may be used for the purposes of the present invention. The sheet material of the present invention will prove particularly advantageous in combination with difficult-to-fuse top fabrics, such as hydrophobic-finished (oleophobic) PES, cotton or cambric top fabrics (hydrophobic finishing) or smooth, coated top fabrics.

The employment of a thermo-fusible sheet material according to the present invention is not restricted to this use, however. Other uses are conceivable, for example, as a fusible textile sheet material in home textiles such as upholstered furniture, reinforced seating structures, seat covers or as fusible and stretchable textile sheet material in automotive interiors, footwear components or the hygiene/medical sector.

The invention will now be described without loss of generality using the example of a thermo-fusible sheet material of the present invention being used as a fusible interlining in the textile industry.

### WORKING EXAMPLES

### Example 1

### Producing a Thermoplastic TPU Bonding Compound

1000.0 g of polyester polyol (1,4-butanediol adipate, OH number: 56, functionality: 2) were introduced into a 3 L metal bucket as initial charge and maintained in an evacuating station at 90° C. under vacuum for two hours for devolatilization and dewatering. The polyol was subsequently heated with a hotplate to 100° C. Under efficient agitation, 0.02 g of Dabco T95 catalyst, 33.1 g of a chain extender mixture of 1,4-butanediol and 2,3-butanediol in a ratio of 80:20, 5.9 g of Stabaxol P200 hydrolysis control agent and 140.0 g of the isocyanate 1,6-hexamethylene diisocyanate were admixed in succession. Following admixture of the diisocyanate, a strongly exothermic reaction started, which led to a rapid increase in the reaction temperature together with a simultaneous increase in the viscosity of the reaction mixture. In the case described, the reaction mixture was poured out on attainment of a substantially constant temperature maximum. To this end, the bucket contents were poured into a casting mold formed of Teflon film and positioned on a hotplate at 100° C. The mixture reacted in full in the course of 30 minutes at 100° C.

The polyurethane obtained had a Shore hardness of 85° A and a melting range of 105 to 115° C.

### Example 2

### Producing a Thermoplastic TPU Bonding Compound

1000.0 g of polyester polyol (1,4-butanediol adipate, OH number: 56, functionality: 2) were introduced into a 3 L metal bucket as initial charge and maintained in an evacuating station at 90° C. under vacuum for two hours for devolatilization and dewatering. The polyol was subsequently heated with a hotplate to 100° C. Under efficient agitation, 0.02 g of Dabco T95 catalyst, 33.2 g of the chain extender mixture of 1,4-butanediol, 5.9 g of Stabaxol P200 hydrolysis control agent and 140.0 g of the isocyanate 1,6-hexamethylene diisocyanate were admixed in succession. Following admixture of the diisocyanate, a strongly exothermic reaction started, which led to a rapid increase in the reaction temperature together with a simultaneous increase in the viscosity of the reaction mixture. In the case described, the reaction mixture was poured out on attainment of a substantially constant temperature maximum. To this end, the bucket contents were poured into a casting mold formed of Teflon film and positioned on a hotplate at 100° C. The mixture reacted in full in the course of 30 minutes at 100° C.

The polyurethane obtained had a Shore hardness of 87° A and a melting range of 110 to 120° C.

### Example 3

### Producing a Sheet Material

A nonwoven fabric base composed of 85% polyamide and 15% polyester and having a basis weight of 18 g/m² was coated using the familiar double point process. The underpoint was made therein using a binder which, in addition to the commonly used assistants, such as emulsifiers, thickeners and processing aids, also contained a filming polyester polyurethane (add-on: 2.5 g/m²). While the underpoint was still wet, an aliphatic polyester polyurethane having a melting point of 108-116° C. and an MFI value of 25 (g/10 minutes at 160° C./load of 2.16 kg) was sprinkled onto it as overpoint, the excess was sucked off, followed by drying at 185° C. (add-on: 5 g/m²). A similar manner was used to apply an acrylate binder underpoint to the same base and sprinkle it with a polyamide powder. The melting point of the polyamide is 108-112° C. coupled with an MFI value of 49 (g/10 minutes at 160° C./load of 2.16 kg). These interlinings were fused with a temperature of 120° C. for 12 seconds and a pressure of 2.5 bar (using a Multistar 1000 CU press). The fabric used was a polyurethane-coated top fabric (J. L. Ball Article: 31198). The table which follows shows the primary delamination resistance, the delamination resistance following dry cleaning and the delamination resistance following a 60° C. wash.

TABLE 1

| | Polyamide bonding | PU bonding |
|---|---|---|
| | compound system | compound system |
| primary adherence | 0.7 | 10.7 |
| [N/5 cm] | | |
| 1 × dry cleaning | 0.4 | 8.7 |
| [N/5 cm] | | |
| 1 × 60° C. wash | 0.2 | 9.5 |
| [N/5 cm] | | |

### Example 4

### Producing a Nonwoven-Based Sheet Material

A 100% polyester nonwoven fabric base having a basis weight of X g/m² was coated using the familiar double point process. The underpoint was made therein using a binder which, in addition to the commonly used assistants, such as emulsifiers, thickeners and processing aids, also contained a filming polyester polyurethane (add-on: 1.8 g/m²). While the underpoint was still wet, an aliphatic polyester polyurethane having a melting point of 98-108° C. and an MFI value of 56 (g/10 minutes at 160° C./load of 2.16 kg) was sprinkled onto it as overpoint, the excess was sucked off, followed by drying at 185° C. (add-on: 5.4 g/m²). A similar manner was used to apply an acrylate binder underpoint to the same base using thermoplastic polymers on polyamide and polyester base and sprinkled with a polyamide powder. The melting point of the polyamide is 108-112° C. coupled with an MFI value of 49 (g/10 minutes at 160° C./load of 2.16 kg). These interlinings were fused with a temperature of 120° C. for 12 seconds and a pressure of 2.5 bar (using a Multistar 1000 CU press). The fabric used in addition to a coated top fabric (J. L. Ball Article: 31050) was a conventional top fabric on a polyester/cotton base (65%/35%) which is used as the standard top fabric in the lab because it is representative for a whole series of conventional top fabrics. The table which follows shows the primary delamination resistance and the delamination resistance following a 60° C. wash for both the top fabrics.

TABLE 2

| | Polyamide bonding | Polyurethane bonding |
|---|---|---|
| | compound system | compound system |
| primary adherence to | 3.3 | 4.6 |
| PES/Co | | |
| [N/5 cm] | | |
| primary adherence to | 0.3 | 7.1 |
| coated top fabric | | |
| [N/5 cm] | | |
| 1 × 60° C. wash of | 2.7 | 3.7 |
| PES/Co | | |
| [N/5 cm] | | |
| 1 × 60° C. wash of | 0 | 4.6 |
| coated top fabric | | |
| [N/5 cm] | | |

The above example makes clear that custom-tailored polyurethane bonding compound systems not only provide substantially improved adherence to difficult-to-fuse coated top fabrics, but also achieve an at least equivalent performance to commonly used polyamide or polyester systems on conventional, uncoated top fabrics.

### Example 5

### Producing a Knit-Based Sheet Material

A knitted base (100% polyester) with 22 g/m² basis weight is coated using the familiar double point process. Not only a “standard” bonding compound system comprising a thermoplastic underpoint and polyamide as sprinkled powder was used in said process but also a double point system comprising a polyurethane binder underpoint and an aliphatic polyester polyurethane as sprinkled powder. The underpoints were made using pastes formulated with the customary assistants, such as emulsifier, thickener and processing aids. In the case of the thermoplastic binder underpoint, the paste contained not only an acrylate binder but also thermoplastic polymers on a polyamide and polyester base. To produce the overpoint, a polyamide having a melting point of 113° C. and an MFI value of 71 (g/10 min) (determined at 160° C. under a load of 2.16 kg) was sprinkled onto the underpoint. The TPU paste, in addition to the standard components, contains a binder component in the form of an aliphatic polyester polyurethane dispersion. The sprinkled powder applied for the overpoint was in this case a thermoplastic, aliphatic polyester polyurethane having a melting point of 112° C. and an MFI value of 25 (g/10 min) (determined at 160° C. under a load of 2.16 kg).

In the course of the coating operation, 2.5 g of underpoint binder paste were applied and covered with 5 g of sprinkled powder. These interlinings were fused with a temperature of 130° C. for 12 seconds and a pressure of 2.5 bar (using a Kannegiesser EXT 1000 CU press). The fabric used was a polyurethane-coated top fabric (J. L. Ball Article: 31198). The table which follows shows the primary delamination resistance, the delamination resistance following dry cleaning and the delamination resistance following a 60° C. wash.

TABLE 3

| | Polyamide bonding | PU bonding |
|---|---|---|
| | compound system | compound system |
| primary adherence | 2.4 | 23.5 |
| [N/10 cm] | | |
| 1 × dry cleaning | 0.8 | 21.9 |
| [N/10 cm] | | |
| 1 × 60° C. wash | 0 | 17.2 |
| [N/10 cm] | | |

But it is also in respect of “conventional”, uncoated top fabrics that the polyurethanes develop similar adhesive forces to the familiar polymer systems based, for example, on polyamide or polyester.

### Example 6

### Air Permeability Measurements

In accordance with EN ISO 9237 but with the following differences:
No conditioning
Standard conditions to DIN 50014/ISO 554
Test result in dm³/s*m²
   Tester: Textex FX 3300
   Test pressure: 50 Pa, 100 Pa or 200 Pa
   Sample width: 10 cm

Air permeability measurements were carried out with two difficult-to-fuse polyurethane-coated top fabrics and two conventional, uncoated reference top fabrics. The results are shown in the table which follows:

TABLE 4

| Test | Air permeability in dm³/s*m² | | | |
|---|---|---|---|---|
| pressure | | | J.L. de Ball | J.L. de Ball |
| [Pa] | Cambric | PES/Co blue | (Article: 31050) | (Article: 31198) |
| 50 | 61.9 | 7.9 | 1.9 | 0 |
| 100 | 117 | 15.6 | 3.6 | 0 |
| 200 | 226 | 32.2 | 6.9 | 0 |

It is clear from the results that the two coated top fabrics have a very much lower level of air permeability than the two uncoated top fabrics have. Air transmission is nearly prevented by the uninterrupted, smooth functional layer. One other consequence of the smooth functional layer is a surface which is extremely difficult to bond to adhesively. This surface layer may be constructed of a very wide range of materials, for example polyurethane-based, fluorocarbon-based or silicone-based materials.

### Example 7

### Performance of Hysteresis Measurements

Testing on a Zwick machine using the following variables:

web tensile force direction: transverse

sample width: 50 mm

clamped length: 200 mm

pretensioning force: 0.05 N

speed cycle: 500 mm/min

test conditions: 22° C./50% relative humidity

Hysteresis measurements were carried out on three samples of 18 g/m² basis weight and 85% polyamide/15% polyester nonwoven fabric samples coated using the double point process. The elasticity in the transverse direction was determined in the hysteresis measurements. Interlining 1 was coated with a system of polyurethane binder underpoint and polyurethane bonding compound. Interlining 2 has an acrylate underpoint and a polyamide overpoint. Both interlinings are coated with 7.5 g/m² of bonding compound (2.5+5 g/m²). Interlining 3 corresponds in its coating to interlining 1 except that the add-on has increased to 11 g/m² (5+6 g/m²).

The hysteresis measurements on the inventive sheet materials were carried out on a Zwick machine in two ways:

1) by closed loop position control at up to 25% strain (upper turn point)

2) by closed loop force control at up to 2 N (upper turn point)

The measured results are shown in Tables 5 to 7.

re 1) Operation under closed loop position control makes clear that interlining 1, comprising the polyurethane bonding compound system, has a significantly smaller permanent elongation and hence is significantly more elastic than interlining 2, comprising the polyamide bonding compound. It is clear from interlining 2 that the permanent elongation is significantly higher and that the value decreases to a greater extent not only in the individual cycle but also across the 5 cycles. In the case of interlining 1, by contrast, the permanent elongation changes only minimally across the cycle. These two effects are further amplified by raising the add-on of the polyurethane bonding compound system (interlining 3).

re 2) The same effects are observed under closed loop force control. The permanent elongation is significantly higher for interlining 2 than for the polyurethane-coated interlinings 1 and 3. The permanent elongation of interlining 2 during the 5 series of measurements is at 15-20% significantly higher and also decreases to a significantly greater degree within only one cycle of measurement than for the polyurethane-coated interlinings 1 and 3 (the measured curves shift to the right). The effect of elasticity gain through an increase in the elastically acting polyurethane point coating is likewise confirmed once more (compare interlining 1 with interlining 3).

The measured results are shown in Tables 8 to 10.

Hysteresis measurement of interlining 1

TABLE 5

| | | Permanent | Force at 5% | Force at 10% | Force at 20% |
|---|---|---|---|---|---|
| No. | Index | elongation % | load N | load N | load N |
| 1 | 1 | 7.11 | 0.49 | 0.96 | 1.85 |
| | 2 | 8.22 | | 0.23 | 1.20 |
| | 3 | 8.81 | | 0.17 | 1.09 |
| | 4 | 9.23 | | 0.13 | 1.03 |
| | 5 | 9.59 | | 0.11 | 0.98 |
| 2 | 1 | 7.07 | 0.46 | 0.91 | 1.77 |
| | 2 | 8.28 | | 0.22 | 1.15 |
| | 3 | 8.78 | | 0.16 | 1.03 |
| | 4 | 9.28 | | 0.13 | 0.97 |
| | 5 | 9.57 | | 0.10 | 0.93 |
| 3 | 1 | 6.88 | 0.49 | 0.98 | 1.90 |
| | 2 | 7.98 | | 0.25 | 1.26 |
| | 3 | 8.61 | | 0.18 | 1.13 |
| | 4 | 9.11 | | 0.15 | 1.06 |
| | 5 | 9.29 | | 0.12 | 1.02 |
| 4 | 1 | 6.79 | 0.52 | 1.01 | 1.97 |
| | 2 | 7.88 | | 0.25 | 1.29 |
| | 3 | 8.54 | | 0.19 | 1.16 |
| | 4 | 8.91 | | 0.15 | 1.09 |
| | 5 | 9.29 | | 0.13 | 1.05 |
| 5 | 1 | 7.31 | 0.46 | 0.91 | 1.79 |
| | 2 | 8.53 | | 0.21 | 1.16 |
| | 3 | 8.91 | | 0.15 | 1.04 |
| | 4 | 9.54 | | 0.13 | 0.99 |
| | 5 | 9.81 | | 0.09 | 0.94 |

Hysteresis measurement of interlining 2

TABLE 6

| | | Permanent | Force at 5% | Force at 10% | Force at 20% |
|---|---|---|---|---|---|
| No. | Index | elongation % | load N | load N | load N |
| 1 | 1 | 11.04 | 0.32 | 0.58 | 1.22 |
| | 2 | 12.54 | | | 0.73 |
| | 3 | 12.97 | | | 0.65 |
| | 4 | 13.40 | | | 0.61 |
| | 5 | 13.71 | | | 0.58 |
| 2 | 1 | 11.09 | 0.27 | 0.55 | 1.20 |
| | 2 | 12.36 | | | 0.71 |
| | 3 | 13.06 | | | 0.63 |
| | 4 | 13.54 | | | 0.59 |
| | 5 | 13.92 | | | 0.56 |
| 3 | 1 | 12.19 | 0.23 | 0.40 | 0.85 |
| | 2 | 13.35 | | | 0.50 |
| | 3 | 13.93 | | | 0.44 |
| | 4 | 14.34 | | | 0.41 |
| | 5 | 14.92 | | | 0.39 |
| 4 | 1 | 12.51 | 0.21 | 0.39 | 0.81 |
| | 2 | 13.71 | | | 0.47 |
| | 3 | 14.23 | | | 0.42 |
| | 4 | 14.75 | | | 0.39 |
| | 5 | 14.99 | | | 0.37 |
| 5 | 1 | 11.97 | 0.22 | 0.40 | 0.86 |
| | 2 | 13.37 | | | 0.52 |
| | 3 | 14.38 | | | 0.46 |
| | 4 | 14.25 | | | 0.42 |
| | 5 | 14.90 | | | 0.41 |

Hysteresis measurement of interlining 3

TABLE 7

| | | Permanent | Force at 5% | Force at 10% | Force at 20% |
|---|---|---|---|---|---|
| No. | Index | elongation % | load N | load N | load N |
| 1 | 1 | 6.11 | 0.83 | 1.56 | 2.85 |
| | 2 | 7.08 | | 0.41 | 1.91 |
| | 3 | 7.72 | | 0.31 | 1.73 |
| | 4 | 8.08 | | 0.26 | 1.63 |
| | 5 | 8.41 | | 0.22 | 1.58 |
| 2 | 1 | 6.13 | 0.80 | 1.56 | 2.90 |
| | 2 | 7.22 | | 0.41 | 1.96 |
| | 3 | 7.81 | | 0.30 | 1.78 |
| | 4 | 8.27 | | 0.25 | 1.68 |
| | 5 | 8.62 | | 0.21 | 1.62 |
| 3 | 1 | 6.27 | 0.70 | 1.37 | 2.61 |
| | 2 | 7.36 | | 0.35 | 1.75 |
| | 3 | 7.91 | | 0.26 | 1.59 |
| | 4 | 8.34 | | 0.22 | 1.50 |
| | 5 | 8.62 | | 0.19 | 1.44 |
| 4 | 1 | 6.34 | 0.72 | 1.39 | 2.64 |
| | 2 | 7.35 | | 0.35 | 1.76 |
| | 3 | 8.01 | | 0.27 | 1.60 |
| | 4 | 8.41 | | 0.21 | 1.52 |
| | 5 | 8.79 | | 0.19 | 1.47 |
| 5 | 1 | 6.35 | 0.68 | 1.33 | 2.55 |
| | 2 | 7.35 | | 0.34 | 1.72 |
| | 3 | 8.01 | | 0.26 | 1.56 |
| | 4 | 8.36 | | 0.21 | 1.48 |
| | 5 | 8.64 | | 0.19 | 1.42 |

Hysteresis measurement of interlining 1

TABLE 8

| | | Permanent |
|---|---|---|
| No. | Index | elongation % |
| 1 | 1 | 6.32 |
| | 2 | 7.61 |
| | 3 | 8.28 |
| | 4 | 8.95 |
| | 5 | 9.49 |
| 2 | 1 | 6.14 |
| | 2 | 7.22 |
| | 3 | 7.92 |
| | 4 | 8.53 |
| | 5 | 9.02 |
| 3 | 1 | 5.40 |
| | 2 | 6.49 |
| | 3 | 7.14 |
| | 4 | 7.68 |
| | 5 | 8.09 |
| 4 | 1 | 6.39 |
| | 2 | 7.49 |
| | 3 | 8.39 |
| | 4 | 8.87 |
| | 5 | 9.39 |
| 5 | 1 | 6.62 |
| | 2 | 7.99 |
| | 3 | 8.70 |
| | 4 | 9.31 |
| | 5 | 9.82 |

Hysteresis measurement of interlining 2

TABLE 9

| | | Permanent |
|---|---|---|
| No. | Index | elongation % |
| 1 | 1 | 19.77 |
| | 2 | 22.18 |
| | 3 | 23.50 |
| | 4 | 24.63 |
| | 5 | 25.27 |
| 2 | 1 | 17.84 |
| | 2 | 19.58 |
| | 3 | 20.71 |
| | 4 | 21.90 |
| | 5 | 22.23 |
| 3 | 1 | 19.70 |
| | 2 | 22.01 |
| | 3 | 23.53 |
| | 4 | 24.34 |
| | 5 | 25.19 |
| 4 | 1 | 14.96 |
| | 2 | 16.73 |
| | 3 | 17.99 |
| | 4 | 18.90 |
| | 5 | 19.24 |
| 5 | 1 | 15.32 |
| | 2 | 17.10 |
| | 3 | 18.13 |
| | 4 | 18.93 |
| | 5 | 19.70 |

Hysteresis measurement of interlining 3

TABLE 10

| | | Permanent |
|---|---|---|
| No. | Index | elongation % |
| 1 | 1 | 3.74 |
| | 2 | 4.56 |
| | 3 | 5.05 |
| | 4 | 5.36 |
| | 5 | 5.78 |
| 2 | 1 | 4.11 |
| | 2 | 4.95 |
| | 3 | 5.44 |
| | 4 | 5.96 |
| | 5 | 6.19 |
| 3 | 1 | 4.18 |
| | 2 | 5.05 |
| | 3 | 5.41 |
| | 4 | 6.41 |
| | 5 | 6.11 |
| 4 | 1 | 4.28 |
| | 2 | 5.02 |
| | 3 | 5.50 |
| | 4 | 5.91 |
| | 5 | 6.27 |
| 5 | 1 | 4.06 |
| | 2 | 5.05 |
| | 3 | 5.62 |
| | 4 | 5.94 |
| | 5 | 6.32 |

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A thermo-fusible sheet material, comprising:
a backing ply comprising a textile material supporting a bonding compound structure,
wherein the bonding compound structure comprises a polyurethane hotmelt composition comprising a thermoplastic polyurethane, which is a reaction product of reactants comprising (A) a
bifunctional polyisocyanate having an isocyanate content of 5 to 65 proportional parts by weight, and
(B) a polyol comprising a polyester polyol, polyether polyol, polycaprolactone polyol, polycarbonate polyol, copolymer of polycaprolactone polyol polytetrahydrofuran, or a mixture of two or more of any of these,
wherein the bonding compound structure is a two-ply bonding compound structure comprising
an underlayer, lying directly on the sheet material, and
an overlayer, arranged on the underlayer and comprising the thermoplastic polyurethane bonding compound, and
wherein the under layer comprises a binder comprising a polyurethane having a melting point >190° C., a thermoplastic polyurethane having a melting point <190° C., or both.

2. The material of claim 1, wherein the polyol (B) comprises
a polyester polyol having a molecular weight of 400 g/mol to 6000 g/mol,
a polyether polyol having a molecular weight of 400 g/mol to 6000 g/mol,
a polycaprolactone polyol having a molecular weight of 450 g/mol to 6000 g/mol,
a polycarbonate polyol having a molecular weight of 450 g/mol to 3000 g/mol,
a copolymer of polycaprolactone polyol and polytetrahydrofuran polyol having a molecular weight of 800 g/mol to 4000 g/mol,
or a mixture of two or more of any of these.

3. The material of claim 1, wherein the bifunctional polyisocyanate (A) comprises C_{4-C18} aliphatic diisocyanate, a C₆₋₂₀ cycloaliphatic diisocyanate, a C₆₋₂₀ aromatic diisocyanate, or a mixture of two or more of any of these, having isocyanate contents of 5 to 65 proportional parts by weight.

4. The material of claim 1, wherein the reactants further comprise (C) a chain extender, and
wherein the chain extender comprises ethylene glycol, 1,2-propanediol, 1,3-propanediol, 1,4-butanediol, 1,3-butanediol, 2,3-butanediol, an isomeric mixture of butanediol, 1,5-pentanediol, an isomeric mixture of pentanediol, cyclohexanedimethanol (CHDM), 1,6-hexanediol, an isomeric mixture of hexanediol, or a mixture of two or more of any of these.

5. The material of claim 1, wherein a reaction of the reactants takes place in the presence of a modifier comprising a catalyst, a hydrolysis control agent, an aging control agent, or a mixture of two or more of any of these.

6. The material of claim 1, wherein the reactants further comprise (C) a chain extender, and
wherein a reaction of the reactants takes place in a quantitative ratio of A to B plus C corresponding to a molar ratio of NCO to OH of from 0.7 to 1.0.

7. The material of claim 1, wherein the reactants further comprise (C) a chain extender, and
wherein a reaction of the reactants takes place in a quantitative ratio of A to B plus C corresponding to a molar ratio of NCO to OH of from 0.8 to 0.9.

8. The material of claim 1, wherein a melting range of the thermoplastic polyurethane hotmelt composition lies between 60° C. to 190° C.

9. The material of claim 1, wherein the textile material is a woven fabric, a knitted fabric, or a nonwoven fabric.

10-11. (canceled)

12. The material of claim 1, wherein the overlayer, the underlayer, or both further comprise a further thermoplastic polymer comprising a (co)polyester, (co)polyamide, polyolefin, ethylene-vinyl acetate, a copolymer of two or more of any of these, or a mixture of two or more of any of the preceding.

13. The material of claim 1, wherein the binder comprises acrylate, styrene acrylate, ethylene-vinyl acetate, butadiene-acrylate, SBR, polyurethane, or a mixture of two or more of any of these.

14. A process for producing the thermo-fusible sheet material of claim 1, the method comprising:
(a) providing the backing ply,
(b) applying the bonding compound structure
to one or more selected areal regions of the backing ply, and
(c) thermally treating the backing ply from (b) to sinter the thermoplastic polymer onto or with surface of the backing ply.

15. The method of claim 12, further comprising:
forming an interlining, configured to fuse to a top fabric, out of the thermo-fusible sheet material.

16. The method of claim 15, carried out in the presence of a coating comprising silicone, fluorocarbon, or a thermoplastic polyurethane on at least a side of the top fabric facing the interlining.

17. A fusible interlining, comprising the thermo-fusible sheet material of claim 1.

18. The interlining of claim 17, having an air permeability <100 dm³/s*m² at a test pressure of 200 Pa

19. The material of claim 1, wherein the polyisocyanate (A) is aliphatic.

20. The material of claim 1, wherein the polyisocyanate (A) is cycloaliphatic.

21. The material of claim 1, wherein the polyisocyanate (A) is aromatic.

22. The material of claim 6, wherein the quantitative ratio is from 0.94 to 0.98.
